(19) United States
(12) Patent Application Publication
(10) Pub. No.: US 2013/0098804 A1
(43) Pub. Date: Apr. 25, 2013

(54) Method of catalyst making for superior attrition performance

(71) Applicants: Yun-feng Chang, Houston, TX (US); Lian Du, Tianjin (CN)

(72) Inventors: Yun-feng Chang, Houston, TX (US); Lian Du, Tianjin (CN)

(21) Appl. No.: 13/317,615

(22) Filed: Oct. 24, 2011

(51) Int. Cl. C10G 11/00; B01J 29/40; B01J 29/08; B01J 29/04

(52) U.S. Cl. 208/113; 502/60; 502/64; 502/68; 502/77; 502/79

(57) ABSTRACT

A catalyst composition that has superior attrition performance and a method that produces said catalyst composition to be used for fluid catalytic cracking processes to convert a heavy hydrocarbon fraction into mainly liquid fuels, particularly gasoline and light olefins. The catalyst composition has a moisture level or loss on ignition below 12 wt % and attrition rate below 3 wt. %/hr.

### FIELD OF THE INVENTION

The present invention provides a composition of catalyst and a process for forming said catalyst.

### BACKGROUND OF THE INVENTION

Catalysts are key enablers for converting crude oil into liquid fuels for vehicles, heating oils, petrochemical feedstock, for converting coal into more valuable products, for example, methanol, or liquid fuel feedstock combing with gasification, converting biomass into chemical feedstock, for example, oxygenates. Catalytic activity is a key measurement of a catalyst material, however, it is far from being the only determining factor. In many applications, their other properties, for example, mechanical strength, their form or size and shape, their density, and last but not least their dynamic behavior in terms of reacting or deactivating or regenerateability.

Catalysts consist of at least one active component, and an additive, sometimes, called matrix, and often than not a binder to make into a shape product. Active components include but limited to synthetic zeolites or molecular sieves, synthetic clays, natural occurring zeolites, clays, modified natural zeolites and clays, charcoals, chars, carbon blacks, high surface area metal oxides, for example, alumina, silica, amorphous alumina-silica, carbon molecular sieves, metal-organic frameworks (MOFS), layered materials, for example, anionic clay, hydrotalcite. The active component provides the key catalytic functionality. The additive or matrix fulfills part of requirement for cost consideration, density, thermal stability. The binder is essential to make the final composite product mechanically more durable.

By definition, catalysts are material that participate in catalytic cycles but do not consume during the process, thus, in theory, they could last for indefinitely. In reality, not only do catalyst deactivate, do they also be consumed. For many processes, consumption of catalyst is a key consideration factor for overall economics and environmental compliance. Catalyst consumption or loss comes from two main sources, irreversible deactivation and physical removal from the reactor system that cannot be recovered or too costly to recover it or reversal is not practical. Catalysts suffer from high loss rates when they are used in a demanding reaction environment, for example, high temperatures, high material transportation rates, and how high catalyst to feed ratios. The most widely used and the highest processing capacity of any petrochemical processes, fluid catalytic cracking (FCC) for making liquid fuels and other valuable fuels or chemicals of modern petrochemical industry, is the best example. For a world class FCC unit, it processes many hundred thousands to a million barrels of crude oil per day, requires adding 3-5 tons of fresh catalyst to make up catalyst losses. This represents a major economic debit and environmental concerns because of release of catalyst fines into the atmosphere. Therefore, there is a strong demand for a catalyst that has drastically a lower loss rate.

Economic growth in Asia, particularly in China, has spurred gasoline demand starting 1990's. The technology behind gasoline production is a catalytic process called fluidized catalytic cracking, or widely known as, FCC process. It employs a microspherical catalyst to convert a petroleum fraction into cracked gasoline or FCC gasoline. A key requirement for this catalyst is that it is highly active for converting large hydrocarbon molecules into a fraction of C₄-C₁₀ that has rather high octane numbers. This cracking function is predominantly provided by acid sites. To have high activity, both large number of acid sites and high acid strength are required. The combination of these two features often results in high coke make which lessens catalyst life time. To maintain catalyst activity, continuous coke burn is required to either partly or fully regenerate the coked or deactivated catalyst sites. To mitigate coke formation, microporous solids acids, or zeolites are used. The small pore size and three-dimensionality provide significant reduction in coke formation. The most widely used zeolite is stabilized synthetic faujasite, also called ultra-stabilized Y zeolite or USY, rare earth exchanged Y zeolite or called REY, rare earth incorporated USY, called REUSY. USY is usually prepared by high temperature steaming treatment of common synthetic faujasite zeolite.

Another functionality of modern FCC catalyst is its ability to do deep cracking, making ethylene and propylene or prime olefins and other lower olefins. These olefins are used either to make high octane alkylates through an alkylation reaction or to be used for polyolefins. Typically, this function is achieved by introducing ZSM-5 zeolite into the catalyst. ZSM-5 is particularly effective in making propylene and ethylene.

FCC is commercially carried out in a cyclic mode. The hydrocarbon feed is contacted with the catalyst at 400° C. to 650° C., and at ambient to 50 prig pressure in the presence or absence of added hydrogen. For fluidization purpose, the catalyst particles are in the form of microspheres in the size range of 20 to 200 microns. Too small particles (<20 microns) are carried out of the reaction system as fines or dust due to the high gas velocity employed, ranging from 5 m/sec to 100 msec. However, too big particles, for example, 200 microns or bigger, can lead to hydrodynamic problems of poor mixing or poor catalyst distribution and server erosion to contacting surfaces in reactor and regenerator. Ideally, average FCC catalyst particles are 60-100 microns. Catalyst particles are lifted upwardly through a riser reaction zone, fluidized and thoroughly mixed with the hydrocarbon feed, or called oil. The oil or hydrocarbon feed is cracked in the reaction zone at temperatures of 450-650° C., leading to desired gasoline, and other products, like light olefins, less desired gas oil and undesired carbonaceous materials, or coke remained on catalyst particles. Products are separated and recovered. Coke laden catalyst particles or deactivated catalysts are sent to regenerator where they are reactivated by burning off the carbonaceous deposits in the presence of oxygen introduced as air.

Regeneration is typically carried out at temperatures between 450° C. and 650° C. in the presence of air, and often in the presence of an oxidizing catalyst additive. This allows a more thorough coke removal and least or no formation of carbon monoxide. Once stripped coke the regenerated catalyst particles are sent back to the riser reactor for cracking. This cycle of cracking-regenerating may repeat a large number of times depending on catalyst activity (or unit throughput) requirement, mechanical strength of catalyst particles, and cost of catalyst. Regeneration can lead to major regaining of catalyst activity but often than not, incomplete restoration of catalyst activity. The incomplete restoration of catalytic activity in part is due to incomplete coke removal and in part results from hydrothermal deactivation of the catalyst. The latter arises from structural degradation of the zeolite component or other components, i.e., reduction in crystallinity, dealumination or loss of acid sites, permanent poisoning of active sites by impurities. Consequently, to maintain a steady catalyst activity or unit throughput, fresh catalyst has to be added into the FCC unit to compensate the loss of catalyst due to fine generation and inability to regain all catalytic activity. This is called catalyst make up. Numerous improvements have been made to reduce catalytic activity loss due to these structural degradations by incorporating stabilizer, like rare earth elements into the zeolite, hydrothermal stabilization, and employing binder that provides stabilization to the zeolite structure. Therefore, catalyst make up rate to compensate structural deactivation is significantly reduced. Another area of improvement comes from hardware. By improved design in reactor internals, break down of catalyst particles is significantly reduce, this includes more stable catalyst movement, reduction in sharp turns and more smooth reactor surfaces or applying coatings on reactor walls that are in contract with catalyst particles that act as a cushioning layer.

Despite improvements in hardware, control system, and catalyst, modern FCC operation still requires high catalyst make up rate. This is the result of high operation severity in terms of temperature, catalyst circulation rate, and catalyst to feed (oil) ratio in the reaction section and in the regenerator to maximize selectivity to gasoline and other valuable olefins products and continuous drive for high unit throughput. A combination of high operating temperature, high catalyst circulation rate, and low catalyst to oil ratio, and higher number of regeneration cycles leads to significantly more mechanical breakdown of the catalyst particles. Catalyst debris or catalyst fines less than 20 microns are produced from this mechanical breakdown. This fine generation is generally called attrition. Due to their small sizes and the high gas velocity, it is very difficult to keep these fine particles in the FCC unit even with the most advanced separation and recovery devices, i.e., multi-stage cyclones. High fines generation translates into high catalyst loss rate. It has to be compensated by fresh catalyst addition, or catalyst make up. The amount of fresh catalyst added to maintain steady state FCC performance per unit time, or catalyst makeup rate, is a key economic and unit operation barometer to gauge the catalyst performance and operation integrity. Not only do high makeup rate costs more money directly but also leads to even higher operating cost because that more catalyst fines have to be managed per unit mass of product produced to meet regulatory and environmental requirements for waste disposal or additional cost associated with more equipment required or more sophisticated equipment required to monitor and manage the fines generated to meet various local and government regulations. For a world scale FCC unit, the amount of makeup catalyst used can be 5 tons per day (t/d) to 20 t/d depending on the size of the FCC unit and type of catalyst used. This translates into 1800 tons per year to 7200 tons per year per FCC unit. Therefore, there is a high incentive to reduce catalyst loss due to attrition.

FCC catalyst consists of a zeolite component, a binder, and a matrix material. The zeolite component, for example, a USY zeolite or ZSM-5, or a combination of a number of zeolites or molecular sieves provide majority of the catalytic activity. The binder, for example, alumina, or silica, provides mechanical strength by linking the zeolite crystallites. Some binders may also provide some level of catalytic activity. Matrix material, for example, a clay, usually, kaolin clay, serves a multitude of purposes, ranging from densification of the ultimate catalyst particles, porosities required for better diffusion characteristics. In addition to these three key components other modifiers or components are introduced to improve stability of the zeolite component, to reduce coke formation, and to improve resistance to metal deactivation.

### DESCRIPTION OF THE INVENTION

The present invention provides a composition and method of preparing cracking catalyst that has high activity and low attrition losses.

“FCC catalyst” refers to catalytic materials used in a fluidized bed catalytic process to convert a petroleum fraction into a primarily gasoline fraction. The catalyst is a solid acid that facilitates selective cracking of a petroleum fraction to give a high octane number gasoline product. In addition to cracking it also performs other functions, i.e., some removal of heteroatom containing components, and some formation of high octane products including aromatics. Nowadays, deep cracking to make light olefins, for instance ethylene, propylene, is a desired feature.

Due to high reaction severity to achieve high conversion efficiency and to maximize gasoline production, catalyst has to be operated under low catalyst to oil (hydrocarbon fraction) ratio and very high gas space velocity. Because of the high linear velocity of catalyst particles during conversion process at elevated temperatures, more catalyst particles breakdown to smaller particles. Smaller particles may be carried away as catalyst fines and dust left the reactor. To maintain overall system throughput (to compensate catalyst loss and decline in catalyst activity), fresh catalyst has to be added, or so called catalyst make-up. The higher the catalyst loss due to catalyst breakdown, the higher catalyst make-up rate, naturally, the higher catalyst operating cost. In additional to the cost factor, high catalyst fine formation could lead to unacceptable levels of dust released into air. Therefore, it is highly desired to have a catalyst composition with high activity and low catalyst loss rate.

“Catalyst activity” refers to the amount of given petroleum fraction converted to a gasoline fraction under defined conversion conditions, e.g., temperature, feed rate, pressure, per unit time per unit mass of catalyst. On equal mass basis, if a first catalyst that converts twice as much of feed as a second catalyst, it is said that the first catalyst is twice as active as the second catalyst or the catalyst activity of the first catalyst is twice as that of the second catalyst.

“Catalyst loss rate” refers to the amount of catalyst lost due to physical breakdown during conversion process for a given process per unit time. For example, for one hundred grams of fresh catalyst loaded into reactor a loss of one gram during a conversion process in a period of one hour, the catalyst rate is 1 wt %/hr. The higher the catalyst loss rate the higher catalyst make rate has to be used in order to maintain the same production throughput. A high catalyst makeup rate leads to a high cost of operation.

“Attrition loss rate” is defined as catalyst loss due to physical abrasion, attrition, or grinding of catalyst particles during use in catalytic conversion processes. It is often measured using an apparatus, called attrition unit. One example of such unit is described by Weeks and Dumbill, published in Oil & Gas Journal, pp. 38-40, 1990. The attrition unit consists of a jet cup, an elutriate chamber, and a fines collection thimble. A known amount of catalyst particles in the size range of 40-125 microns is loaded into the jet cup where catalyst particles are accelerated by a high velocity gas jet produced by gas coming out of an orifice. Particles traveling at high speed upwards from the bottom of the unit enter into the elutriation chamber, due to the huge expansion of the volume velocity of the travelling particles drop substantially, and eventually fall because of gravity. It is this particle-particle collision, robbing catalyst particles against inner surfaces of attrition unit that leads to breakdown of the catalyst particles. The fragments or debris produced during this process is called catalyst fines often smaller than 20 microns. These fines are collected in a fiber glass thimble. The fines produced can be accurately measured. Based on the duration of the attrition operation, an attrition rate, or the amount of fines produced per unit time relative to the total amount of catalyst loaded into the unit can be calculated. Attrition loss rate is a strong function of gas velocity. The higher the gas velocity the greater catalyst attrition loss rate is. For a given gas linear velocity, for a catalyst loading of 6.0 grams into the attrition unit, if the amount of fines generated during a period of 3 hours is 0.36 grams, the attrition loss rate or attrition rate (AR) is: (0.36/6)*100/3=2 wt. %/hr. The lower the attrition rate the more attrition resistant are the catalyst particles. For FCC catalysts, their attrition rate typically varies between 2 wt. %/hr and 20 wt. %/hr measured at gas linear velocity of 100 m/sec at room temperature and atmospheric pressure. Sometime this kind of attrition rate measurement is termed as Davison Index (DI) originally developed by Davison Division of W.R. Grace & Co as described in “Advances in Catalytic Cracking”, Advanced Technology Program, Catalytica Inc., Part 1, p. 355, 1987. Attrition index measured by a similar apparatus, called Attrition Index Apparatus (AIA) developed by Alcoa Corporation is similar to that of Davison Index (I. A. Pedersen, J. A. Lowe, and C. R. Matocha Sr., in Characterization and Catalyst Development: An Interactive Approach edited by S. A. Bradley, M. J. Gattuson, and R. J. Batolacini, ACS Symp. Ser. 411, pp. 414-429, ACS, Washington D.C., 1989).

“Apparent bulk density” refers to the density determined by pouring a given amount of catalyst particles (record weight of the catalyst added) into a measuring device, for example, a 25 cc gradual cylinder having the dimensions of 18 mm inside diameter and 90 mm height at the 25 cc mark with an accuracy to 0.1 cc. Ideally, at least 12 cc of catalyst volume is required. Once the sample is poured in the cylinder it was tapped at the bottom again a solid lab bench surface for a total of 60 times in 20-25 seconds. Level the top layer of the catalyst for accurate reading of the volume and record the catalyst volume after tapping. For example, for 15.282 grams of catalyst, if it takes 18.85 cc volume after tapping, its apparent bulk density (ABD) is: 15.782/18.85=0.816 g/cc.

“Catalyst particle” refers to catalyst of given size and shape applied to a given conversion process. For FCC application, the average particle size is in the range of 30 microns to 250 microns, most often in the range of 60 microns to 120 microns, for fluid dynamics consideration and in the form of microspheres.

“Particle size distribution (PSD)” describes the relative proportion of individual particle size present in a mix of particle sizes. For fluidization purpose, a certain particle size distribution (PSD) is desired. This is typically defined by a set of particle sizes, for instance, d₁₀, d₅₀, and d₉₀. d₁₀, is the size 10% of the total particle volume is at or below this size. Likewise, d₅₀ is the size 50% of the total particle volume is at or below this size. d₁₀ measures how small the small particles or “fines”. d₅₀ measures the average particle size. d₉₀ measures size of the oversize particles.

Particle size or particle size distribution (PSD) are obtained by well known techniques like (1) sedigraph, for example, Micromeritics SediGraph 5000E, SediGraph 5100 based on particle sedimentation measured by x-ray, it measures particles in the range of 0.5-250 microns; (2) laser scattering, which measures light scattering by particles, particularly small particles, for example, Horiba LA910, Microtrac S3500, Microtrac UPA, Microtrac FRA, measuring particles in the range of 10 nm to 3000 microns; (3) acoustic and electro-acoustic techniques, for example, Matec ESA 9800, Matec AZR-Plus, and Dispersion Technologies DT-1200, measuring particles in the range of 30 nm to 300 microns; (4) ultracentrifugation, in particular, disc centrifuge, for example CPS Instruments DC2400, measuring particles from 5 nm to 75 microns; Dispersion Analyzer LUMiSizer® for particle size from 10 nm to 2000 microns; (5) electroresistance counting method, an example of this type is the Coulter counter, which measures the momentary changes in the conductivity of a liquid passing through an orifice that takes place when individual non-conducting particles pass through. The particle count is obtained by counting pulses, and the size is dependent on the size of each pulse; (6) high sensitivity electrophoretic laser scattering technique, like Brookhaven Instruments ZetaPals and ZetaPlus, measuring particles of 3 nm to 10 microns; (7) electron microscopic imaging, scanning electron microscopy (SEM) and transmission electron microscopy (TEM) can determine both particle size and morphology. Under ideal conditions, particles as small as 1-2 nm to as big as 1 mm can be measured; (8) optical microscopy, it can measure particle size from 1 micron to 10 mm. For typical catalyst formulation samples, particle sizes to be analyzed range from a few nanometers to a few millimeters. Often time, more than one technique is required to get the full distribution. More comprehensive dealing of particle size measurements using light scattering can reference the book, “Particle Characterization: Light Scattering Method”, by Renliang Xu, Kluwer Academic Publisher, Dordrecht, The Netherlands, pp. 1-24, 2000. More generic treaty of fine particle characterization can be found in monograph “Analytical Methods in Fine Particle Technology”, by P. A. Webb and C. Orr, Micromeritics Instrument Corp., Norcross, Ga., pp. 17-28, 1997. More comprehensive dealing of particle characterization and preparation can reference the book by J-E. Otterstedt and D. A. Brandreth, “Small Particles Technology”, Plenum Press, New York, p. 8, 1998; and book by A. M. Spasic and J-P. Hsu, “Finely Dispersed Particles: Micro-, Nano-, and Atto-Engineering”, Taylor & Francis, Roca Raton, pp. 329-340, 2006. “Catalyst formulation and shaping” refers to a mixture containing various components to be used to make a finish catalyst product with defined size, shape and other physical attributes, including for example, density or bulk density, mechanical strength, etc. Catalyst formulation can be a slurry, a paste, or dough like semisolid depending on solids content of the mixture. Known techniques used for making shaped catalyst products include spray drying, extrusion, oil-drop spherical particle formation, pelletization, and granulation.

“Spray drying” refers to a process where a catalyst formulation in the form of slurry is atomized and dried in an apparatus called spray dryer. Atomization is achieved using (1) a pressure nozzle, (2) two-fluid nozzle, or (3) a vane wheel atomization. The droplets formed have a very high surface area. Their encounter with heating medium, for example hot air or other hot gas or gas mixture can lead to fast evaporation or drying, generating spherical catalyst particles. Droplets size varies with solids content of the slurry, particle size of the slurry, size of the atomizer orifice, pressure used for atomization in the case of pressure nozzle or gas flow for two-fluid atomizer, or wheel speed in the case of wheel atomizer. They vary between 20 microns to 300 microns. Consequently, the spherical particles due to drying of the corresponding droplets results in formation of 10 to 150 microns spherical or near spherical catalyst particles. Spray drying temperature is varied between 100° C. and 550° C. For a given gas flow rate, the higher the drying gas temperature, the greater the drying capacity.

“Active component” herein is referred to the material that gives rise to predominant catalytic activity. For FCC catalyst, the active component is referred to the USY zeolite or other zeolitic or molecular sieves. In this invention, active component and zeolite is used interchangeably. “Binder” is referred to the component added to the catalyst formulation that its presence has led to major improvement in catalyst ability to resist to physical breakdown. Depending on binder type, binder's function or effect may only be realized once it has gone through a physical and chemical transformation. For example, an aluminum sol is converted into a gamma alumina when it is calcined at temperatures higher than 500° C. Binders are essential to provide mechanical strength of the finish catalyst particles. Widely accepted binders include colloidal alumina, colloidal silica, and other colloidal sols or precursors.

“Matrix” is referred to the material added to FCC catalyst formulation that its introduction is not for activity enhancement nor binding enhancement, but rather, to increase particle density, to improve thermal stability through particle compaction. Known matrix materials used in FCC catalyst formulation include kaolin clay and other clays or metal oxides. However, some matrix materials may also provide some level of catalytic activity.

“FCC additive” refers to components introduced into the FCC catalyst to achieve or enhance properties other than those provided by the three essential components, active, binder, and matrix. Rare earth (RE) elements are widely used to enhance hydrothermal stability of the zeolite component. Other metal oxides are introduced to help to retain or trap metal present in the FCC feed to reduce deactivation caused by these metal, particularly, Ni, V. For example, antimony is found particularly effective to reduce metal migration or poisoning to catalyst. Hettinger, “Catalysis Challenges and Some Possible New and Future Directions for Even Further Improvement”, Catalysis Today, 53, 367-384 (1999), provides a through account of various modifiers introduced into FCC catalysts including magnetic materials to help catalyst separation. Other additives are introduced to reduce NOₓ, SOₓ formation. Another component introduced into FCC is an oxidizing component to reduce CO formation in the regenerator. A known example of these additives is Pt supported on alumina.

“Slurry or suspension” is referred to a mixture of catalyst components and a dispersing agent, for example, water, and a stabilizing agent or other additives to form a suspension or slurry. To achieve slurry uniformity, mixing or milling devices are used.

“Mixer or mill” refers to equipment or devices used to achieve homogenization of the catalyst components in the slurry. This includes low shear mixers, blade mixers, saw blade mixers, high shear mixers, for example, Silverson high shear mixer, medium mills, for example Eiger mills, Netzsch mills. In addition to homogenization, particle size reduction is also accomplished. Mixing or milling can be achieved in either a batch mode or continuous circulation mode or combination of both.

Known milling techniques include but not limited to ball milling, roller milling, sonication, high-shear milling, and medium milling.

In one embodiment, milling is achieved by using a high-shear mixer or mill or a medium mill or mixer or combination of both.

It is preferred that after milling particle size d₅₀ or average particle size is reduced by at least 5% from for example 20 microns to 19 microns. It is even more preferred that after milling, d₅₀ is reduced by at least 10% from for example 20 microns to 18 microns. It is most preferred that after milling d₅₀ is reduced by at least 15% from for example 20 microns to 17 microns. It is recognized that to maximize milling throughput and efficiency a high solids content slurry is desired. However, it is also recognized that slurries having high solids content often encounter high viscosity making them difficult to homogenize, difficult to transport and even more difficult to be milled. Therefore, it is highly desired to have a process that is capable of handling high solids content slurries.

In one embodiment, transportation means that can handle high solids materials, for example, a positive displacement pump is used to carry out slurry transportation from the mixing tank to the mill, for example, Moyno 1000 pump from Moyno Inc., Springfield, Ohio.

In one embodiment, a modifier is added to the slurry so that slurry viscosity can be significantly reduced. It is preferred that the surface modifier added can lead to reduction in slurry viscosity by at least 5%, that is from for example 20,000 cps to 19,000 cps, more preferably at least 10%, that is from for example 20,000 cps to 18,000 cps, and most preferably by at least 15%, that is from for example 20,000 cps to 17,000 cps.

In one embodiment, the modifier is an ionic additive or water soluble polymer or dispersing regent selected from inorganic acids, low molecular weight organic acids, polyacids, cationic and anionic water soluble polymers.

In another embodiment, the amount of stabilizing agent added is at least 30 parts per million by weight (wt ppm). It is more preferred that the amount is at least 45 ppm. It is most preferred that the amount is at least 50 ppm.

“Solids content” of the slurry or suspension is defined as the amount of solids particles or residue left after a treatment at elevated temperatures to drive off water, or any other volatiles, or combustion to burn off organics. For example, treatment of catalyst slurry sample at 550° C. for 2 hours in air resulted in a residue whose mass is 45% of the original mass, that is the solids content of this sediment sample is 45 wt %. The solids content is collection of active catalyst component, binder, matrix and other introduced materials derived products after the calcination treatment.

“Loss on ignition (LOI)” is used to determine the amount of weight loss of a material after a treatment, often time, referring to calcination, at 550° C. for two hrs. It usually used to indicate the amount of moisture retained by the material or serves as a measurement of organic or volatile organic present in the material. If a material having a starting weight of 100 grams, after calcination at 550° C. for 2 hrs, its weight becomes 94.5 grams, then its LOI is: [(100 grams−94.5 grams)/100 grams*100]=5.5 wt. %.

“Surface modifier, dispersant or dispersion aid” refers to a class of components or chemicals that their addition in a small amount to a slurry or suspension can result in a significant improvement in dispersion, that is (1) increased rate of breakdown of large lumps, (2) better wetting of dry particles or powder introduced into the slurry or suspension; (3) reduced viscosity. These changes or improvements are closely related to alteration in surface properties, surface charge, charge density or zeta potential. Detail list of different types of surface modifier or surfactants can be found in “Surfactants and Interfacial Phenomena”, Chapter 1, 3^{rd} Edition, by M. J. Rosen, John Wiley & Sons, Hoboken, N.J., 2004. They include, ionics, cationic, anionic, and zwitterionic; and non-ionics.

Zwitterionics contain both an anionic and a cationic charge under normal conditions, for example molecules containing a quaternary ammonium as the cationic group and a carboxylic group as the anionic group. For ionic surface modifiers the higher the charge density the more effective in surface modification. For example, according to Patton (T. C. Patton, Paint Flow and Pigment Dispersion-A Rheological Approach to Coating and Ink Technology, 2nd Edition, John Wiley & Sons, New York, p. 270, 1979), efficacy of cations or anions in surface modification increased from monovalent to divalent to trivalent in a ration of 1:64:729.

Non-ionic surface modifiers are polyelthylene oxide, polyacrylamide (PAM), partially hydrolyzed polyacrylamide (HPAM), and dextran.

Anionic surface modifiers include, carboxylate, sulfate, sulfonate and phasphate are the polar groups found in anionic polymers. Examples of water soluble anionic polymer are: dextran sulfates, high molecular weight ligninsulfonates prepared by a condensation reaction of formaldehyde with ligninsulfonates, and polyacrylamide. Commercially available anionic water soluble polymers include polyacrylamide, CYANAMER series from Cytec Industries Inc., West Paterson, N.J., like, A-370M12370, P-35/P-70, P-80, P-94, F-100L & A-15; CYANAFLOC 310L, CYANAFLOC 165S.

Cationic surface modifiers: The vast majority of cationic polymers are based on the nitrogen atom carrying the cationic charge. Both amine and quaternary ammonium-based products are common. The amines only function as an effective surface modifier in the protonated state; therefore, they cannot be used at high pH. Quaternary ammonium compounds, on the other hand, are not pH sensitive. Ethoxylated amines possess properties characteristic of both cationic and non-ionics depending on chain length. Examples of water soluble cationic polymers are: polyethyleneimine, polyacrylamide-co-trimethylammonium ethyl methyl acrylate chloride (PTAMC), and poly(N-methyl-4-vinylpyridinium iodide. Commercially available materials include: Cat Floc 8108 Plus, 8102 Plus, 8103 Plus, from Nalco Chemicals, Sugar Land, Tex.; polyamines, Superfloc C500 series from Cytec Industries Inc., West Paterson, N.J., including C-521, C-567, C-572, C-573, C-577, and C-578 of different molecular weight; poly diallyl, dimethyl, ammonium chloride (poly DADMAC) C-500 series, C-587, C-591, C-592, and C-595 of varying molecular weight and charge density, and low molecular weight and high charge density C-501.

Zwitterionics: Common types of zwitterionic compounds include N-alkyl derivatives of simple amino acids, such as glycine (NH₂CH₂COOH), amino propionic acid (NH₂CH₂CH₂COOH) or polymers containing such structure segments or functional group.

High catalyst loss rate or high attrition of FCC catalysts has been recognized for a long period of times. Numerous attempts have been made. For example, U.S. Pat. No. 4,572,439 to Pitzer, used ultrasound energy to destroy the weaker FCC catalyst particles leaving only the more attrition resistant catalyst particles to achieve better attrition performance. This treatment does not lead to any improvement in catalyst attrition performance but provides a mean to rejecting poor attrition particles. The economic debits for Pitzer's approach are two folds: cost of this treatment and loss of materials due to removal (destruction) of the weaker particles.

U.S. Pat. No. 6,916,757 to Ziebarth, Roberie, Deitz, disclosed a method of making FCC catalyst with a high amount of phosphorus added to lower attrition rate.

Another attempt, made by U.S. Pat. No. 7,442,664 to van der Zon and Hilgers used polyaluminum chloride as binder to make attrition resistant FCC catalysts, but, the attrition resistance of resultant catalysts are poor, with a Davison Index (DI) at or greater than 6.

Yet, another invention for method of making attrition resistant catalyst support, silica, was disclosed by U.S. Pat. No. 7,135,429 to Raman et al by using a binder, again failed to make a highly attrition resistant catalyst particle.

In U.S. Pat. No. 5,221,648 to Wachter, it tried different binders and varying binder quantities to achieve low attrition. Using a silica binder, despite all formulation and spray drying efforts, it met with a very limited success or improvement in catalyst attrition. Catalyst attrition rate reported as DI (Davison Index) is well over 2.5%/hr.

US 2010/0252484 A1 to Kumar and Kenneth teaches improvement in formulation by lowering slurry temperature before spray drying to improve attrition, but again, it produced only limited improvement.

We have found unexpectedly that a catalyst with a very low LOI gives a substantially lower attrition. Furthermore, we have provided a catalyst composition that has attrition resistance an order of magnitude higher than the best FCC prepared by the prior art, from DI of over 2.5%/hr to below 0.3%/hr.

To further illustrate the present invention, a number of examples are provided below.

### EXAMPLES

### Example-1

### Comparison

A FCC catalyst produced by SINOPEC Changling Catalyst Company, Changling, Hunan, China, TJPC-F, has a LOI of 12.1%, an ABD of 0.90 g/cm³ and attrition rate of 5.87%/hr.

### Example-2

### Invention

Catalyst TJPC-F of Example-1 was calcined in a muffle furnace at 550° C. for 2 hrs in air, resulting in TJPC-F-C1. The TJPC-F-C1 has a LOI of 0.5%, an ABD of 0.81 g/cm³ and an attrition rate of 1.81%/hr.

### Example-3

### Invention

Catalyst TJPC-F of Example-1 was treated in a dry oven with air circulation at 110° C. for various periods of time to dry off moisture from the catalyst. This resulted in catalyst samples with various LOIs depending on drying time. These samples of different LOIs were tested for their attrition performance. The results are given in Table 1.

TABLE 1
Attrition Performance of FCC Catalysts of Different LOI

| | LOI | Attrition Rate |
|---|---|---|
| Sample | (wt %) | (wt %/hr) |
| TJPC-F-C1 (Example-2) | 0.5 | 1.81 |
| TJPC-F-ML1 (Example-3) | 3.95 | 2.32 |
| TJPC-F-ML2-(Example-3) | 8.89 | 3.15 |
| TJPC-F (Example-1) | 12.1 | 5.87 |

### Example-4

### Invention

A slurry having a solids content of 46.15 wt. % was prepared by (1) weighing 328 grams of distilled water; (2) adding 186 grams of concentrated aluminum chlorohydrate solution (LOI: 75.21%) obtained from Dongmen Chemical Co., Shanghai, China under mixing using a homogenizer at 500 RPM. This slurry had a pH=4.5 measured at 26° C.; (3) adding 276 grams of Y zeolite (MSN-0) having LOI of 10.1 wt. % from Huaxin Scientific Co. Ltd., Dongying, Shandong, China, to the slurry from step (2) whiling under mixing; the resultant slurry having a pH=4.8 measured at 34° C.; (4) adding 210 grams of kaolin clay from China Kaolin Clay Company, Suzhou, Jiangsu, China, having LOI of 21.32% while under mixing; the resultant slurry has a pH=4.6 measured at 30° C. This slurry is called SL-240-0. This slurry was sent to a bead mill, Eiger Mini 250 from Eiger Michinery Inc., Grayslake, Ill. The milling medium used was from Tosoh Corporation, Tokyo, Japan. The mill was operated at above 3600 RPM. Upon milling, the temperature of the slurry increased to 33° C. This gives slurry SL-240-1. Its property is presented in Table 2. The slurry was sent through the mill two more times, the final slurry is called SL-240-3. Its property is also provided in Table 2. Viscosity measurement result of this slurry is given in Table 2. Viscosity measurement was carried out using a Brookfield DV-II+ viscometer from Brookfield Engineering Laboratories Inc., Middleboro, Mass., USA. On dried solid basis, the slurry contains 54% USY zeolite, 16% alumina derived from ACH, and 30% clay.

TABLE 2
Viscosity Measurement Result of the Slurries at Different Stages of Milling

| | | | Viscosity | Viscosity | Viscosity | Viscosity | Viscosity |
|---|---|---|---|---|---|---|---|
| | Temperature | | (cPs) @ | (cPs) @ | (cPs) @ | (cPs) @ | (cPs) @ |
| Slurry | (° C.) | pH | 5 RPM | 10 RPM | 20 RPM | 50 RPM | 100 RPM |
| SL-240-0 | 30 | 4.6 | 5780 | 3660 | 2450 | 1584 | NA |
| SL-240-1 | 31 | 4.7 | 5440 | 3240 | 1860 | 1240 | 836 |
| SL-240-3 | 33 | 4.7 | 6320 | 3760 | 2420 | 1384 | 880 |

This slurry was spray dried using a Yamato DL-41 spray dryer from Yamato Scientific Co., Tokyo, Japan. Atomization was accomplished by a two-fluid Spraying Systems atomization nozzle from Spraying Systems Co., Wheaton, Ill. Outlet temperature was maintained at 75±5° C. while inlet temperature was kept at 235° C. Feed was delivered to the atomizer using a Masterflex peristaltic pump from Cole-Parmer, Vernon Hills, Ill. Products were collected in the cyclone collection vessel. The amount of spray dried products collected represented near 100% of what is expected from the slurry fed into the spray dryer. The spray dried product has a LOI of 27.9%. Attrition measurement was performed on the calcined product. Calcination was carried out in a muffle furnace. It was calcined at 550° C. for 2 hrs. The calcined sample is called SD-240-C1. Attrition measurement was performed on the calcined product. SD-240-C1 gave an attrition rate of 0.03%/hr. Its ABD is 0.87 g/cc.

### Example-5

### Invention

A slurry having a solids content of 46.45 wt. % was prepared by (1) weighing 290 grams of distilled water; (2) adding 241 grams of concentrated aluminum chlorohydrate solution (LOI: 75.21%) obtained from Dongmen Chemical Co., Shanghai, China under mixing using a homogenizer at 500 RPM. This slurry had a pH=4.5 measured at 24° C. (3) adding 276 grams of Y zeolite (MSN-0) having LOI of 10.1 wt. % from Huaxin Scientific Co. Ltd., Dongying, Shandong, China, to the slurry from step (2) whiling under mixing; the resultant slurry having a pH=4.7 measured at 33° C.; (4) adding 193 grams of kaolin clay from China Kaolin Clay Company, Suzhou, Jiangsu, China, having LOI of 21.32% while under mixing; the resultant slurry has a pH=4.7 measured at 30° C. This slurry is called SL-241-0. This slurry was sent to a bead mill, Eiger Mini 250 from Eiger Machinery Inc., Grayslake, Ill. The milling medium used was from Tosoh Corporation, Tokyo, Japan. The mill was operated at above 3600 RPM. Upon milling, the temperature of the slurry increased to 41° C. This gives slurry SL-241-1. Its property is presented in Table 3. The slurry was sent through the mill two more times, the final slurry is called SL-241-3. Its property is also provided in Table 3. Viscosity measurement result of this slurry is given in Table 3. Viscosity measurement was carried out using a Brookfield DV-II+ viscometer from Brookfield Engineering Laboratories Inc., Middleboro, Mass., USA. On dried solid basis, the slurry contains 54% USY zeolite, 13% alumina derived from ACH, and 33% clay.

TABLE 3
Viscosity Measurement Result of the Slurries at Different Stages of Milling

| | | | Viscosity | Viscosity | Viscosity | Viscosity | Viscosity |
|---|---|---|---|---|---|---|---|
| | Temperature | | (cPs) @ | (cPs) @ | (cPs) @ | (cPs) @ | (cPs) @ |
| Slurry | (° C.) | pH | 5 RPM | 10 RPM | 20 RPM | 50 RPM | 100 RPM |
| SL-241-0 | 30 | 4.7 | 13920 | 9560 | 6580 | 4448 | 3624 |
| SL-241-1 | 41 | 4.4 | 6240 | 3640 | 2160 | 1192 | 796 |
| SL-241-3 | 41 | 4.4 | 6320 | 3920 | 2420 | 1320 | 892 |

This slurry was spray dried using a Yamato DL-41 spray dryer from Yamato Scientific Co., Tokyo, Japan. Atomization was accomplished by a two-fluid Spraying Systems atomization nozzle from Spraying Systems Co., Wheaton, Ill. Outlet temperature was maintained at 75±5° C. while inlet temperature was kept at 235° C. Feed was delivered to the atomizer using a Masterflex peristaltic pump from Cole-Parmer, Vernon Hills, Ill. Products were collected in the cyclone collection vessel. The amount of spray dried products collected represented near 100% of what is expected from the slurry fed into the spray dryer. The spray dried product has a LOI of 25.7%. Attrition measurement was performed on the calcined product. Calcination was carried out in a muffle furnace. It was calcined at 550° C. for 2 hrs. The calcined sample is called SD-241-C1. Attrition measurement was performed on the calcined product. SD-241-C1 gave an attrition rate of 0.03%/hr. Its ABD is 0.77 g/cc.

### Example-6

### Invention

A slurry having a solids content of 46.64 wt. % was prepared by (1) weighing 328 grams of distilled water; (2) adding 186 grams of concentrated aluminum chlorohydrate solution (LOI: 75.21%) obtained from Dongmen Chemical Co., Shanghai, China under mixing using a homogenizer at 500 RPM. This slurry had a pH=4.5 measured at 26° C. (3) adding 276 grams of Y zeolite (MSN-0) having LOI of 10.1 wt. % from Huaxin Scientific Co. Ltd., Dongying, Shandong, China, to the slurry from step (2) whiling under mixing; the resultant slurry having a pH=4.8 measured at 34° C.; (4) adding 210 grams of kaolin clay from China Kaolin Clay Company, Suzhou, Jiangsu, China, having LOI of 21.32% while under mixing; the resultant slurry has a pH=4.7 measured at 33° C. This slurry is called SL-242-0. This slurry was sent to a bead mill, Eiger Mini 250 from Eiger Machinery Inc., Grayslake, Ill. The milling medium used was from Tosoh Corporation, Tokyo, Japan. The mill was operated at above 3600 RPM. Upon milling, the temperature of the slurry increased to 44° C. This gives slurry SL-242-1. Its property is presented in Table 4. The slurry was sent through the mill two more times, the final slurry is called SL-242-3. Its property is also provided in Table 4. Viscosity measurement result of this slurry is given in Table 4. Viscosity measurement was carried out using a Brookfield DV-II+ viscometer from Brookfield Engineering Laboratories Inc., Middleboro, Mass., USA. On dried solid basis, the slurry contains 54% USY zeolite, 10% alumina derived from ACH, and 36% clay.

TABLE 4
Viscosity Measurement Result of the Slurries at Different Stages of Milling

| | | | Viscosity | Viscosity | Viscosity | Viscosity | Viscosity |
|---|---|---|---|---|---|---|---|
| | Temperature | | (cPs) @ | (cPs) @ | (cPs) @ | (cPs) @ | (cPs) @ |
| Slurry | (° C.) | pH | 5 RPM | 10 RPM | 20 RPM | 50 RPM | 100 RPM |
| SL-242-0 | 33 | 4.7 | 14160 | 9560 | 6460 | 4216 | 3364 |
| SL-242-1 | 44 | 4.5 | 6480 | 3760 | 2220 | 1200 | 792 |
| SL-242-3 | 38 | 4.5 | 7040 | 40404 | 2420 | 1296 | 852 |

This slurry was spray dried using a Yamato DL-41 spray dryer from Yamato Scientific Co., Tokyo, Japan. Atomization was accomplished by a two-fluid Spraying Systems atomization nozzle from Spraying Systems Co., Wheaton, Ill. Outlet temperature was maintained at 75±5° C. while inlet temperature was kept at 235° C. Feed was delivered to the atomizer using a Masterflex peristaltic pump from Cole-Parmer, Vernon Hills, Ill. Products were collected in the cyclone collection vessel. The amount of spray dried products collected represented near 100% of what is expected from the slurry fed into the spray dryer. The spray dried product has a LOI of 24.7%. Attrition measurement was performed on the calcined product. Calcination was carried out in a muffle furnace. It was calcined at 550° C. for 2 hrs. The calcined sample is called SD-242-C1. Attrition measurement was performed on the calcined product. SD-242-C1 gave an attrition rate of 0.13%/hr. Its ABD is 0.75 g/cc.

To further demonstrate the present invention, key features of comparison and invention examples are presented in Table 5.

TABLE 5
Examples: Comparison and Invention

| | | Sample | | ABD | | BET | Attrition Rate |
|---|---|---|---|---|---|---|---|
| Example | Comments | Description | LOI (%) | (g/cc) | PSD (μm) | (m²/g) | (%/hr) |
| Example-1 | Comparison | TJPC-F | 12.1 | 0.90 | 82 | NA | 5.87 |
| Example-2 | Invention | TJPC-F-C1 | <0.5 | 0.81 | 82 | 267.1 | 1.81 |
| Example-3 | Invention | TJPC-F-ML2 | 8.9 | 0.88 | 82 | NA | 3.15 |
| Example-4 | Invention | SD-240-C1 | <0.5 | 0.87 | 89 | 341.8 | 0.03 |
| Example-5 | Invention | SD-241-C1 | <0.5 | 0.77 | 82 | 353.8 | 0.03 |
| Example-6 | Invention | SD-242-C1 | <0.5 | 0.75 | 87 | 350.0 | 0.13 |

Not only does our invention offer superior attrition performance, as shown in last column of Table 5, but also show superior activity expected from the higher BET surface area as given in the second column from the last column in Table 5.

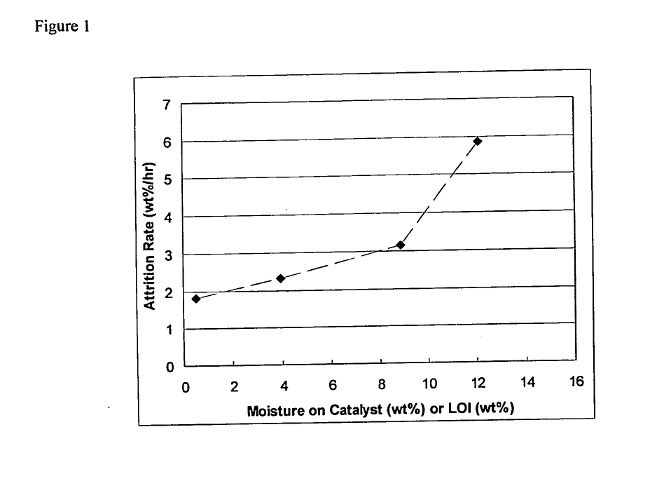

FIG. 1 depicts the relationship between attrition rate and moisture level on catalyst (also known as LOI). A low LOI corresponds to lower attrition rate.

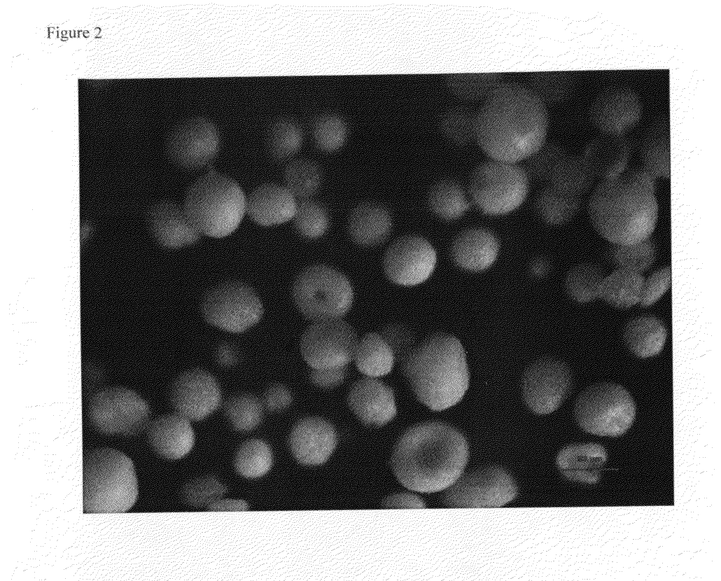

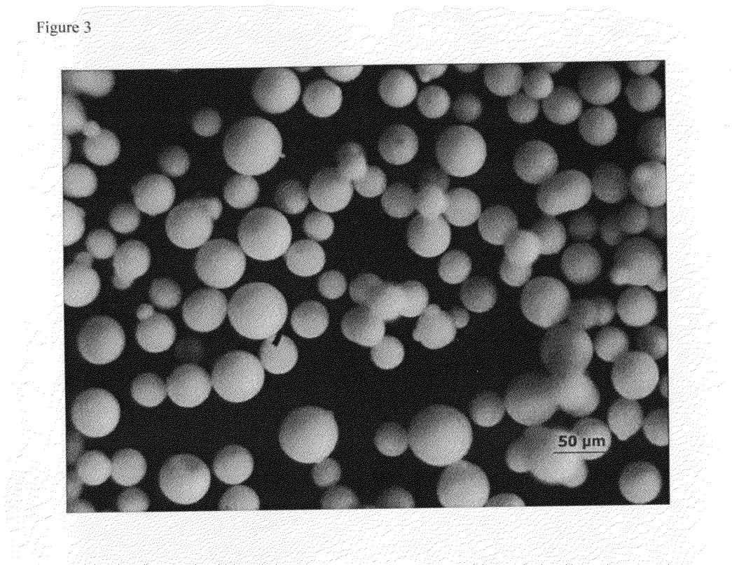

FIG. 2 and FIG. 3 give the optical micrograph images of the comparison catalyst (Example-1) and the invention (Example-6). Catalyst particles of the present invention have superior attrition performance and higher surface area (as shown in Table 5) and better surface uniformity (spherocity) than the prior art (Comparison, Example-1).

Without bound to any particular theory, we have demonstrated substantial reduction in catalyst attrition can be accomplished by lowering LOI of catalyst, furthermore, we have provided a catalyst composition and a method of making to achieve ultra-low attrition loss rate while to maintain high zeolite content through catalyst formulation. To those skilled in the art, it can be envisioned that this invention can be applied to preparation of many different catalyst composition and forms for conversion of hydrocarbons, oxygen containing feedstock under moving or fluidized bed operations.

FIG. 1

Attrition of FCC catalyst varies with LOI (loss on ignition) or moisture level on catalyst. Reduction in LOI results in substantial reduction in attrition loss rate.

FIG. 2

Optical micrograph of catalyst (Comparison) TJPC-F of Example-1: irregularity of catalyst particles.

FIG. 3

Optical micrograph of catalyst (Invention) SD-242-C1 of Example-6: uniformity of catalyst particles.

### REFERENCES

1. S. A. Weeks and P. Dumbill, Oil & Gas J., pp. 38-40 (1990).
2. “Advances in Fluid Catalytic Cracking”, Advanced Technology Program, Catalytica Inc., Mountain View, Calif., Part 1, p. 355, 1987.
3. I. A. Pedersen, J. A. Lowe, and C. R. Matocha, Sr., in “Characterization and Catalyst Development: An Interactive Approach”, edited by S. A. Bradley, M. J. Gattuso, and R. J. Batolacini, ACS Symp. Ser. 411, pp. 414-429, ACS, Washington D.C., 1989.
4. R. L. Xu, “Particle Characterization: Light Scattering Method”, Kluwer Academic Publisher, Dordrecht, The Netherlands, pp. 1-24, 2000.
5. P. A. Webb and C. Orr, “Analytical Methods in Fine Particle Technology”, Micromeritics Instrument Corp., Norcross, Ga., pp. 17-28, 1997.
6. J-E. Otterstedt and D. A. Brandreth, “Small Particles Technology”, Plenum Press, New York, p. 8, 1998.
7. A. M. Spasic and J-P. Hsu, “Finely Dispersed Particles: Micro-, Nano-, and Atto-Engineering”, Taylor & Francis, Roca Raton, pp. 329-340, 2006.
8. W. R. Hettinger, “Catalysis Challenges in Fluid Catalytic Cracking: a 49 year personal account of past and more recent contributions and some possible new and future directions for even further improvement”, Catal. Today, 53, 367-384 (1999).
9. M. J. Rosen, “Surfactants and Interfacial Phenomena”, 3^{rd} Edition, Wiley-Intersciences, Hoboken, N.J., pp. 1-22, 2004.
10. T. C. Patton, “Paint Flow and Pigment Dispersion: A Rheological Approach to Coating and Ink Technology”, 2^{nd} Edition, John Wiley & Sons, New York, p. 270, 1979.

We claim:

1. A catalyst composition comprising of:
(a) a zeolite, a binder precursor, a matrix, optionally a surface modifier, and a slurring medium;
(b) forming a slurry containing a zeolite, a binder precursor, a matrix, and a slurring medium;
(c) mixing and/or milling the slurry to achieve uniform mixing and homogenization of components and to achieve particle size reduction;
(d) a shaping step to convert the said slurry into shaped particles.

2. The composition of claim 1, wherein the slurry contains at least 30 wt % solids, more preferably at least 32 wt %, and most preferably at least 35 wt %.

3. The composition of claim 1, wherein the zeolite is selected from the group of 10-member ring zeolites or pentasils, 12-membered ring zeolites, and meso-porous zeolites with silica to alumina molar ratio of at least 1.5; and wherein the zeolite content on solids basis is at least 30 wt %, more preferably at least 30.5 wt %, and most preferably at least 31 wt %.

4. The composition of claim 1, wherein the binder precursor is selected from a group comprising of aluminum chlorohydrates, colloidal alumina, colloidal silica, colloidal alumina-silica, colloidal metal oxides, or multi-component metal oxides; wherein the binder content on solids basis is at least 5 wt %, more preferably at least 6 wt %, and most preferably at least 7 wt %.

5. The composition of claim 1, wherein the matrix precursor is selected from a group comprising of montmorillonite, bentonite, kaolinite, or a combination of thereof; and wherein the matrix content on solids basis is at least 10 wt %, more preferably at least 12 wt %, and most preferably at least 15 wt %.

6. The composition of claim 1, wherein the slurring agent comprising of water, an aqueous solution, and the slurring agent is at least 10 wt % of the total slurry, more preferably at least 15 wt %, and most preferably at least 20 wt %.

7. The composition of claim 1, wherein a drying and shaping step is applied to convert the slurry into a finished catalyst product, wherein the catalyst particles after drying and shaping have an average particle size d₅₀ of at least 35 microns, more preferably at least 40 microns, and most preferably at least 45 microns.

8. The composition of claim 1, wherein the said catalyst has an attrition loss rate at most 3.0 wt. %/hr, more preferably at most 2.8 wt. %/hr, and most preferably at most 2.5 wt. %/hr, at least 0.01 wt %/hr; and a moisture content or loss on ignition of at most 12 wt %, preferably at most 11 wt %, and more preferably at most 10.5 wt %, and at least 0.01 wt %/hr.

9. A process for preparing a catalyst composition comprising the steps of:
(a) forming a slurry containing a zeolite, a binder precursor, a matrix, optionally a surface modifier, and a slurring medium;
(b) mixing and/or milling the slurry to achieve uniform mixing and homogenization of components and to achieve particle size reduction;
(c) applying a shaping step to convert the catalyst slurry into shaped particles;
(d) optionally applying a drying or calcining step to convert the shaped catalyst particles into a dried or calcined catalyst product to be used for an intended catalytic process.

10. The process of claim 9, wherein the milling device is a high shear mill, a medium mill or combination of thereof.

11. The process of claim 9, wherein upon milling viscosity of the slurry is at least 100 cPs measured at 10 RPM at or near ambient temperature.

12. The process of claim 9, wherein the solids content of the slurry is at least 30%, more preferably at least 32%, most preferably at least 35%.

13. The process of claim 9, where the active components is selected from the group of 10-member ring, 12-member ring zeolite or molecular sieves, including, ZSM-5, Y zeolite, USY, REUSY.

14. The process of claim 9, wherein the binder is selected from the group comprising of colloidal alumina, silica, colloidal metal oxides and their precursors, including aluminum chlorohydrates, or ACH.

15. The process of claim 9, wherein drying and shaping uses a spray dryer.

16. A catalyst composition for converting a heavier hydrocarbon fraction into a lighter hydrocarbon fraction.

17. The composition of claim 16, wherein the lighter hydrocarbon product is mostly C₃-C₁₀ and the liquid fraction having high octane numbers.

18. The composition of claim 16, wherein the catalyst is in the form of microspheres.

19. The composition of claim 16, wherein the catalyst is used in a process for converting a heavier hydrocarbon fraction to a light fraction in a fluidized bed catalytic cracking mode.

20. The process of claim 19, wherein the conversion process is carried out in a continuous process comprising a fluidized bed catalytic cracking reactor and catalyst regenerator at 450° C. to 680° C., where catalyst is continuously added to maintain steady state operation.
